(19) United States
(12) Patent Application Publication
(10) Pub. No.: US 2026/0067612 A1
(43) Pub. Date: Mar. 5, 2026

(54) LOW FREQUENCY RESONATOR AND PRESSURE RELIEF STRUCTURE FOR HEADPHONES

(71) Applicant: Sony Interactive Entertainment Inc., Tokyo (JP)

(72) Inventor: Dragoslav Colich, San Mateo, CA (US)

(21) Appl. No.: 18/825,652

(22) Filed: Sep. 5, 2024

(51) Int. Cl. H04R 1/28; H04R 1/10

(52) U.S. Cl. CPC H04R 1/2873; H04R 1/1008

(57) ABSTRACT

Headphones such as planar magnetic headphones include two ear cups each of which includes a low frequency resonator and pressure relief structure for headphones disc implemented within each ear cup. The low frequency resonator and pressure relief structure for headphones disc is ring-shaped with opposed circular flat surfaces, and at least one arcuate groove is formed in one of the surfaces with a first end of the groove terminating in the endless circular inner periphery of the disc and a second end of the groove terminating in the endless circular outer periphery of the disc.

### FIELD

The present application relates generally to low frequency resonator and pressure relief structures for headphones.

### BACKGROUND

The use of audio headphones for general sound enjoyment of high-fidelity audio is increasing. A non-limiting subset use case for such audio is to provide virtual reality (VR) experiences particularly in computer gaming is increasing. As understood herein, as computer games grow more sophisticated, audio reproduction of ever greater fidelity and range but reasonable cost may be desirable. Note that VR is but one hi-fi audio use case for which present principles may be used.

### SUMMARY

As further understood herein, planar magnetic headphones have been provided such as the one described in commonly-owned U.S. Pat. No. 10,003,876, incorporated herein by reference, and the one described in U.S. Pat. No. 9,287,029, also incorporated herein by reference. As also recognized herein, planar magnetic headphones can produce effective bass sounds but doing this effectively requires very good seals between the earpads and the wearer's head, which can have an adverse effect on reliability. More specifically, when very thin diaphragms are used, the diaphragms can be damaged by high air pressure due to rough handling during headphone adjustments. Air trapped within the earpad can push the thin diaphragm to a destructive excursion if the seal between the earpads and the head is good and the pulse of air pressure is sudden and strong.

Present principles address the technical problems above using a structure with one or more channels to resonate low frequencies, e.g., 20 Hz. Current techniques enhancing low frequency performance in high quality headphones, especially in planar magnetic headphones, while at the same time relieving pressure of air trapped within earpad volume to prevent headphone diaphragm damage during headphone handling or shipping. Pressure relief is very beneficial for active headphones, typically in gaming headphones where low frequencies can easily be adjusted with adequate equalization (EQ) filters, but diaphragm reliability is dramatically increased. With a proper design of the resonating channel structure the lowest frequencies are naturally boosted which helps to reduce power required from the amplifier. In battery powered headphones this is highly beneficial to increase battery life.

Accordingly, an apparatus includes headphones with left and right ear cup assemblies to emit sound. At least a first one of the ear cup assemblies includes a low frequency resonator and pressure relief structure for headphones shaped as a hollow disc with an endless outer periphery, an endless inner periphery, a first flat surface between the peripheries, and second flat surface opposed to the first flat surface. At least the first flat surface is formed with at least a first arcuate channel extending below the first flat surface toward the second flat surface. The first arcuate channel is between the peripheries and distanced therefrom. The first arcuate channel includes a first end segment extending into the inner periphery and a second end segment extending into the outer periphery.

In some examples the peripheries of the hollow disc of the low frequency resonator and pressure relief structure for headphones are round and the channel has a rectilinear transverse cross-section. Or, the cross-sectional shape may be hemispherical or triangular.

In some examples, more than one channel may be provided. For example, a second arcuate channel can be formed in the first flat surface. The first arcuate channel can have a first length and a first cross-sectional size and the second arcuate channel can have a second length equal to the first length and a second cross-sectional size equal to the first cross-sectional size. Or, the second channel may have a different length and/or cross-sectional size than the first channel. Third and even fourth arcuate channels may be formed in the first flat surface. Yet again, the first arcuate channel may have a first longitudinal shape and the second arcuate channel may have a second longitudinal shape different from the first longitudinal shape.

In non-limiting examples, the first arcuate channel can have a width that is continuously tapered along at least a portion of a length of the first arcuate channel.

In some implementations the first end segment may extend into the inner periphery at a first angle relative to the first arcuate channel and the second end segment may extend into the outer periphery at a second angle relative to the first arcuate channel, with the first angle being different than the second angle.

In non-limiting implementations, a rounded edge may be formed between the first arcuate channel and the first end segment. A cover may completely cover the first flat surface. The low frequency resonator and pressure relief structure for headphones may not be part of an inner ear pad or outer plastic shell assembly of the first one of the ear cup assemblies, or it may be part of the inner ear pad or part of the outer plastic shell assembly.

In another aspect, headphones include at least a first ear cup assembly configured to produce sound and at least a first disc in the first ear cup assembly. The first disc is round and hollow and defines an endless outer periphery, an endless inner periphery, a first flat surface between the peripheries, and second flat surface opposed to the first flat surface. At least the first flat surface is formed with at least a first arcuate channel extending below the first flat surface toward the second flat surface and configured to vent to both peripheries.

In another aspect, a method includes providing headphones with left and right ear cups. The method also includes providing, in each ear cup, a low frequency resonator and pressure relief structure for headphones configured with at least one channel configured to resonate sound at a first frequency.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 illustrates a perspective view of a headset that can employ the components divulged herein;

FIG. 2 illustrates an exploded perspective view of an ear cup assembly consistent with present principles;

FIG. 3 illustrates an elevational view of an embodiment in which the low frequency resonator and pressure relief structure for headphones is integrated into the inner ear pad;

FIG. 4 illustrates an elevational view of an embodiment in which the low frequency resonator and pressure relief structure for headphones is integrated into the outer plastic shell;

FIG. 5 illustrates a perspective view of a low frequency resonator and pressure relief structure for headphones consistent with present principles with one channel;

FIG. 6 illustrates a perspective view of a low frequency resonator and pressure relief structure for headphones consistent with present principles with two channels;

FIG. 7 illustrates a perspective view of a low frequency resonator and pressure relief structure for headphones consistent with present principles with three channels;

FIG. 8 illustrates a perspective view of a low frequency resonator and pressure relief structure for headphones consistent with present principles with four channels;

FIG. 9 illustrates a perspective view of a low frequency resonator and pressure relief structure for headphones consistent with present principles with two channels of different lengths;

FIG. 10 illustrates a perspective view of a low frequency resonator and pressure relief structure for headphones consistent with present principles with two channels with different channel cross-sections;

FIG. 11 illustrates a perspective view of a low frequency resonator and pressure relief structure for headphones consistent with present principles with various angles for the inlet and outlet;

FIG. 12 illustrates a perspective view of a low frequency resonator and pressure relief structure for headphones consistent with present principles with two channels with various shapes for the channels;

FIG. 13 illustrates a perspective view of a low frequency resonator and pressure relief structure for headphones consistent with present principles with a channel of varying width;

FIG. 14 illustrates a perspective view of a low frequency resonator and pressure relief structure for headphones consistent with present principles with a channel having a hemispherical cross-section;

FIG. 15 illustrates a perspective view of a low frequency resonator and pressure relief structure for headphones consistent with present principles with a channel having different inlet and outlet angles;

FIG. 16 illustrates a perspective view of a low frequency resonator and pressure relief structure for headphones consistent with present principles with two inlets and two outlets with a common channel connecting them;

FIG. 17 illustrates a perspective view of a low frequency resonator and pressure relief structure for headphones consistent with present principles with two inlets and two outlets with a common oblong channel connecting them;

FIG. 18 illustrates a perspective view of a low frequency resonator and pressure relief structure for headphones consistent with present principles, with the overall structure being in a “D” shape;

FIG. 19 illustrates a perspective view of another example low frequency resonator and pressure relief structure for headphones consistent with present principles with two inlets and two outlets with a common channel connecting them;

FIG. 20 illustrates a perspective view of a low frequency resonator and pressure relief structure for headphones consistent with present principles, where the structure is integrated into a transducer front plate; and

FIGS. 21A and 21B illustrate respective front and rear perspective views of a low frequency resonator and pressure relief structure for headphones consistent with present principles as integrated into earpads.

### DETAILED DESCRIPTION

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

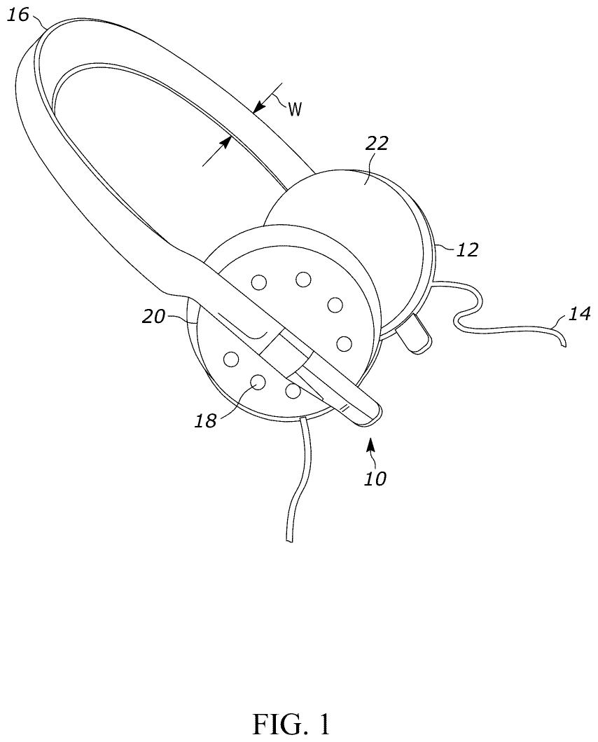

Refer now to FIG. 1. A headphone 10 includes left and right ear cup assemblies 12 that are identical to each other in configuration and operation, the details of one of which are disclosed further below in reference. One or more electrical leads 14 may connect relevant components in the earcup assemblies to a source of audio. Or, the headphone may include a wireless transceiver for receiving audio signals wirelessly.

The ear cup assemblies 12 are connected together by a connector 16, which may be a simple cord or, as shown, a strap or semi-rigid arcuate-shaped arm. In the example shown, the width “W” of the arm is relatively narrow, so as not to block through-holes 18 formed in the outer plastic shell assembly 20 of an ear cup assembly 12. In the example shown, the through-holes 18 are arranged in a circular or ring-shaped pattern. As shown, the outer plastic shell assembly 20 has a circular shape.

The outer plastic shell assembly 20 thus is the outermost portion the ear cup assembly 12 relative to a person's head when the person is wearing the headphones, and thus faces away from the wearer. To provide a comfortable fit for a wearer, the inner-most portion of the ear cup assembly 12 may be a padded hollow cylindrical-shaped ear pad 22 that faces the ear of the wearer. The ear pad may be foam-encased in an outer plastic sleeve. The remaining components of the ear cup assembly 12 are thus disposed between the inner surface of the ear pad 22 and the outer shell assembly 20.

It is to be understood that an ear cup assembly typically includes, in addition to the components shown in the figures and discussed further below, a speaker driver and speaker diaphragm, typically supported in the outer plastic shell assembly 20, to produce sound into a person's ear. In one non-limiting embodiment, such components of the headphones 10 may be implemented by planar magnetic headphones such as but not limited to those described in co-owned U.S. Pat. No. 10,003,876, incorporated herein by reference. However, present principles apply, in addition to planar magnetic headphones, other headphone types including electrostatic, piezoelectric, and dynamic.

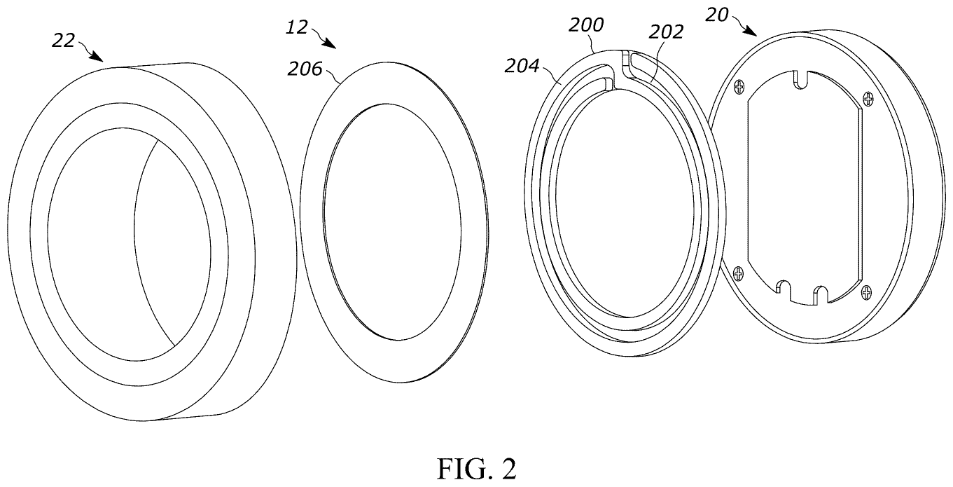

Turning to the salient features consistent with present principles, FIG. 2 illustrates an exploded view of an ear cup assembly 12, showing the inner ear pad 22 and outer plastic shell assembly 20 which contains the diaphragm, driver, and other electrical components of the ear cup assembly 12.

A low frequency resonator and pressure relief structure for headphones 200 is shown disposed between the inner ear pad 22 and outer plastic shell 20. In example embodiments the low frequency resonator and pressure relief structure for headphones 200 may be made of plastic, metal, closed cell foam, or ceramic. In non-limiting examples the base resonator 200 may be formed by laser cutting, laser printing, stamping, die cutting, machining, forging, casting, or injection molding.

As shown in FIG. 2 and described in greater detail below, one or more channels 202 are formed in the inner surface 204 of the low frequency resonator and pressure relief structure for headphones 200 which faces the inner ear pad 22. If desired, a cover disc 206 may cover some or all of the inner surface 204 of the low frequency resonator and pressure relief structure for headphones 200, including the channel or channels 202. The cover 206 may thus be disc-shaped as is the low frequency resonator and pressure relief structure for headphones 200 and may have the same inner and outer diameters as the low frequency resonator and pressure relief structure for headphones 200.

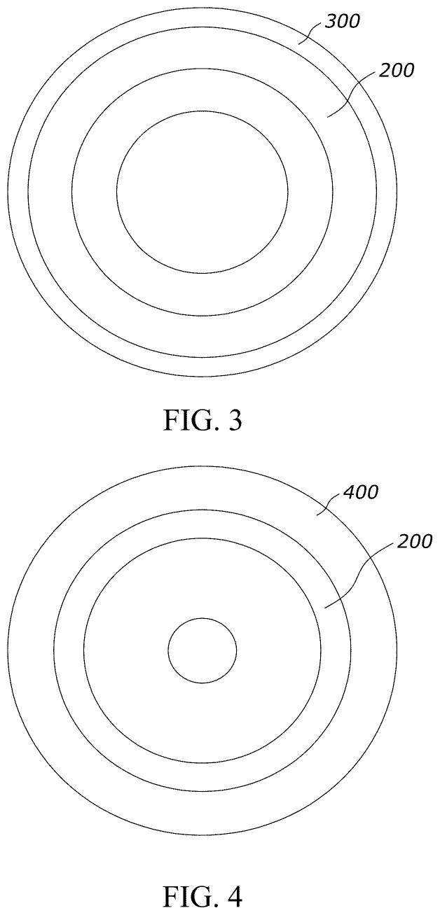

While FIG. 2 illustrates that the low frequency resonator and pressure relief structure for headphones 200 with cover 206 are interposed between the inner ear pad 22 and outer plastic shell 20 as separate components, FIGS. 3 and 4 respectively illustrate that at least the low frequency resonator and pressure relief structure for headphones 200 may be part of an inner ear pad 300 (FIG. 3) or outer plastic shell 400 (FIG. 4).

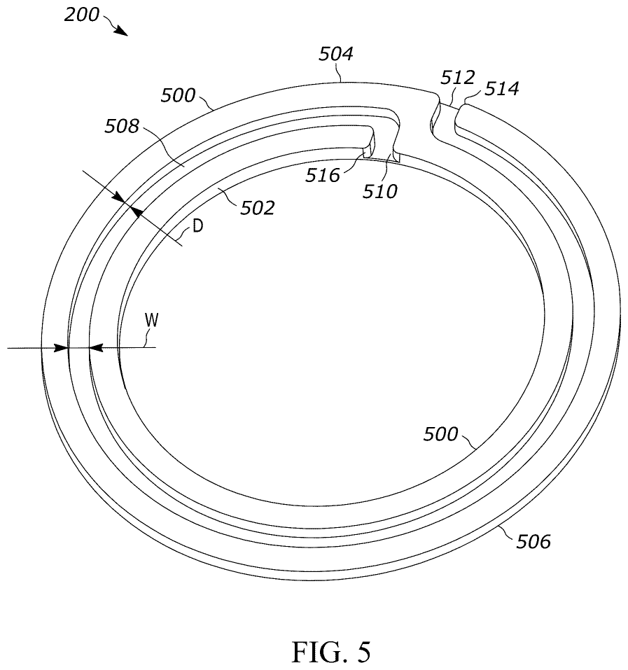

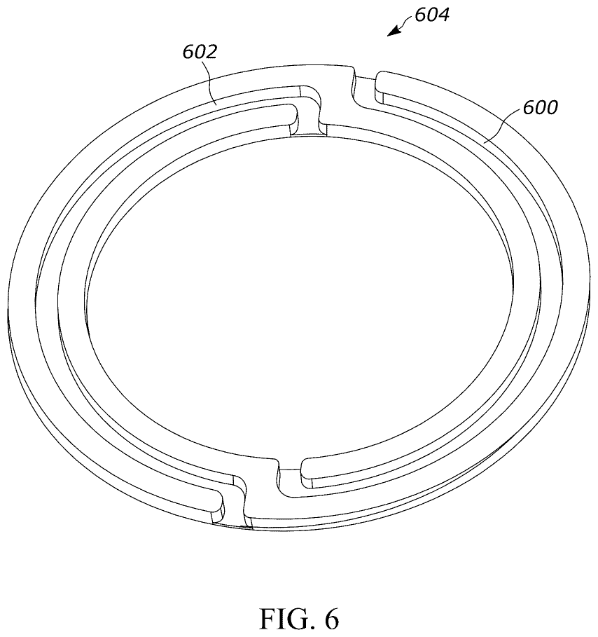

Refer now to FIG. 5, which illustrates a first example of the low frequency resonator and pressure relief structure for headphones 200. As shown, the low frequency resonator and pressure relief structure for headphones 200 may be shaped as a hollow disc with an endless outer periphery 500, an endless inner periphery 502, a first surface 504 between the peripheries 500, 502, and second surface 506 opposed to the first surface 504. In the example shown, both peripheries 500, 502 are circular, although other arcuate-like shapes such as ovular may be used. In the example shown, both surfaces 504, 506 are round and flat, although other shapes may be used.

At least the first surface 504 is formed with at least a first arcuate channel 508. The surface 504 with channel 508 may face either the ear pad 22 or the outer shell assembly 20 shown in FIG. 2.

The channel 508 extends below the first surface 504 toward the second surface 506, and as shown is disposed between the peripheries 500, 502 and distanced therefrom. The channel 508 may have the same arcuate shape as the peripheries 500, 502 and may be parallel to the peripheries 500, 502 as shown.

As shown in FIG. 5, the first arcuate channel 508 includes a first end segment 510 extending into the inner periphery 502 and a second end segment 512 extending into the outer periphery 500. The end segments 510, 512 may be generally perpendicular to the cannel 508. The first end segment 510 may be regarded as an air inlet and the second end segment 512 may be regarded as an air outlet to relieve air pressure and preserve the integrity of the diaphragm of the ear cup assembly. In either case, together the end segments vent fluid in the channel to both peripheries.

In some examples the channel 508 has a rectilinear transverse cross-section as can be appreciated in FIG. 5. If desired, other channel cross-sectional shapes may be used, e.g., arcuate, triangular, or hexagonal.

The channel 508 may define a channel width “W” and a channel depth “D” in the dimension orthogonal to the width “W”. The channel 508 also defines a length from one end segment to the other, and it is to be appreciated that the total volume of the channel is W×D×length.

In non-limiting implementations, a rounded edge 514 is formed between the first arcuate channel 508 and the second end segment 512. If desired, a rounded edge 516 likewise may be formed between the first arcuate channel 508 and the first end segment 510. The shape of the rounded edges 514, 516 reduces edge turbulence of air flowing from end to end in the channel.

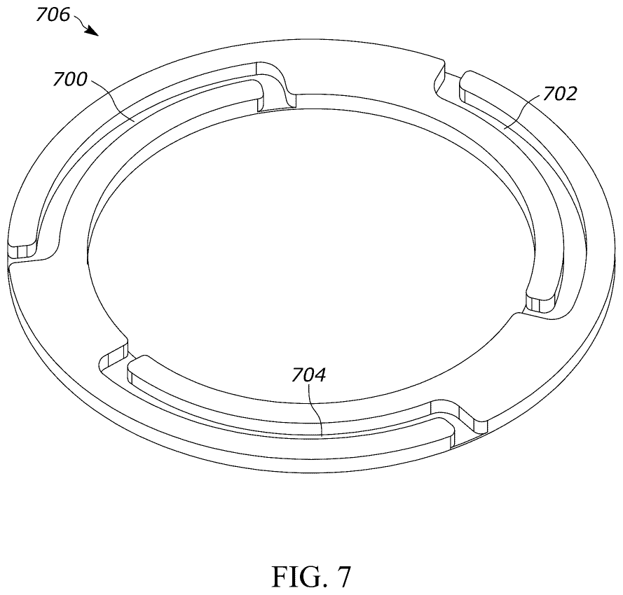

In some examples, more than one channel may be provided. For example, in FIG. 6 first and second channels 600, 602 having equal lengths and cross-sections are formed in a low frequency resonator and pressure relief structure for headphones 604. The channels 600, 602 in the example shown are each of about 180 degrees in circumferential length and do not circumferentially overlap, although if desired the channels can circumferentially overlap. Except for having a shorter circumferential length than the single channel shown in FIG. 5, the channels shown in FIG. 6 incorporate the same principles as set forth in the description of FIG. 5.

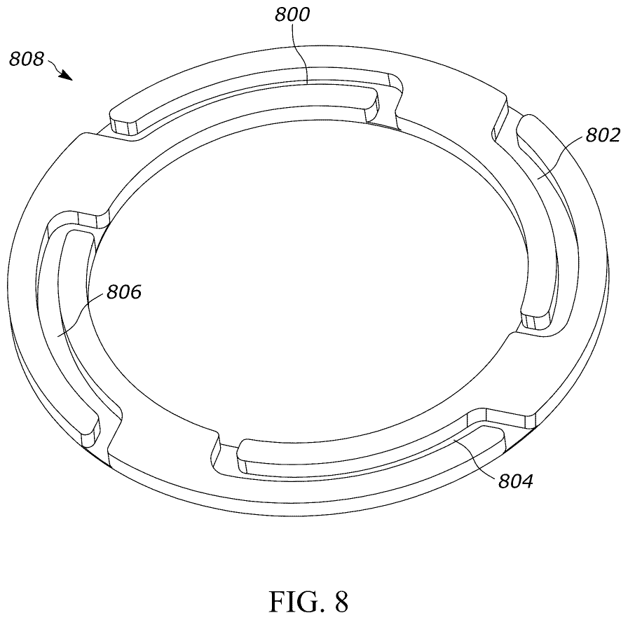

In FIG. 7 first, second, and third channels 700, 702, 704 having equal lengths and cross-sections are formed in a low frequency resonator and pressure relief structure for headphones 706. The channels 700, 702, 704 in the example shown are each of about 120 degrees in circumferential length and do not circumferentially overlap, although if desired the channels can circumferentially overlap. Except for having a shorter circumferential length than the single channel shown in FIG. 5, the channels shown in FIG. 7 incorporate the same principles as set forth in the description of FIG. 5.

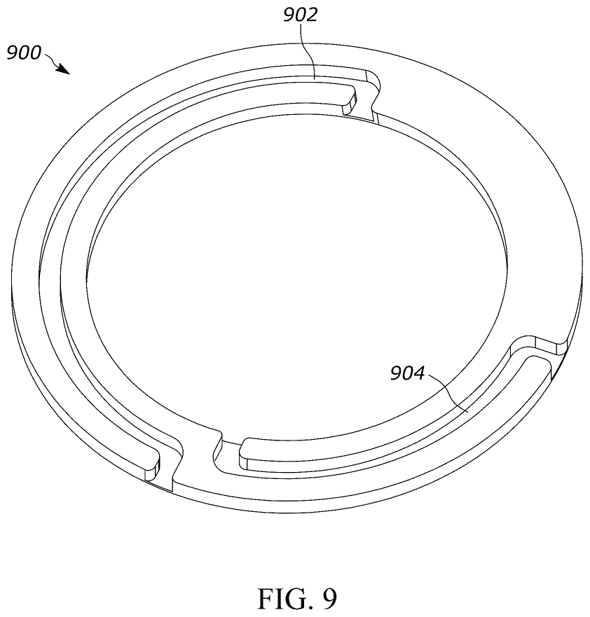

In FIG. 8 first, second, third, and fourth channels 800, 802, 804. 806 having equal lengths and cross-sections are formed in a low frequency resonator and pressure relief structure for headphones 808. The channels 800, 802, 804. 806 in the example shown are each of about 90 degrees in circumferential length and do not circumferentially overlap, although if desired the channels can circumferentially overlap. Except for having a shorter circumferential length than the single channel shown in FIG. 5, the channels shown in FIG. 8 incorporate the same principles as set forth in the description of FIG. 5.

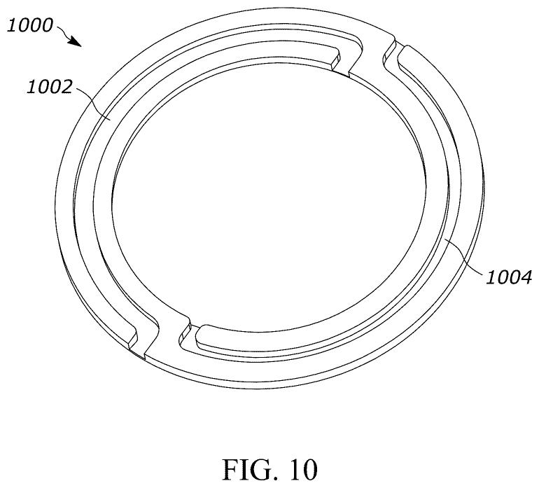

While the multi-channel embodiments in FIGS. 6-8 illustrate channels having the same lengths and cross-sectional areas, FIG. 9 illustrates an embodiment of a low frequency resonator and pressure relief structure for headphones 900 that has a first channel 902 of a first length and a second channel 904 of a second length shorter than the first length. The channels 902, 904 may have the same cross-sectional sizes and shapes as shown, or they may have different cross-sectional sizes and shapes. The length of each channel 902, 904 in FIG. 9 and if desired the cross-sectional size and shape is established to resonate sound at respective first and second frequencies.

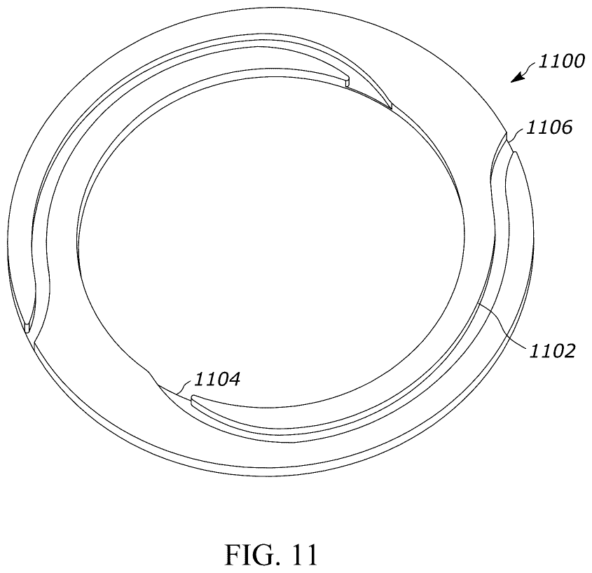

On the other hand, FIG. 10 illustrates an embodiment of a low frequency resonator and pressure relief structure for headphones 1000 that has a first channel 1002 of a first cross-sectional size and shape and a second channel 1004 of a second cross-sectional size smaller than the first cross-sectional size. The cross-sectional size and shape of each channel in FIG. 10 is established to resonate sound at respective first and second frequencies. The channels 1002, 1004 may have the same length as shown, or they may have different lengths.

FIG. 11 illustrates a perspective view of a low frequency resonator and pressure relief structure for headphones 1100 with two channels 1102 showing channel inlets 1104 and outlets 1106 oriented at any appropriate angle.

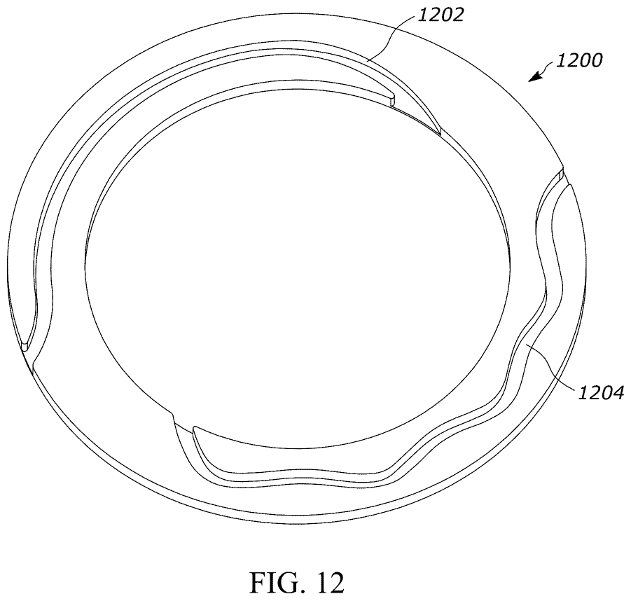

FIG. 12 illustrates a perspective view of a low frequency resonator and pressure relief structure for headphones 1200 with two channels 1202 and 1204. As shown, the first channel 1202 has a continuous arcuate shape along a circular path, whereas the second channel 1204 has a different length and shape than the first channel 1202. The lengths and specific average cross-sections of the two channels are tailored for two different resonant frequencies. The shape of the second channel 1204 is not a continuous arcuate shape along a circular path but instead defines a meandering, somewhat serpentine path. Thus, first channel 1202 has a first longitudinal shape and the second channel 1204 has a second longitudinal shape different from the first longitudinal shape.

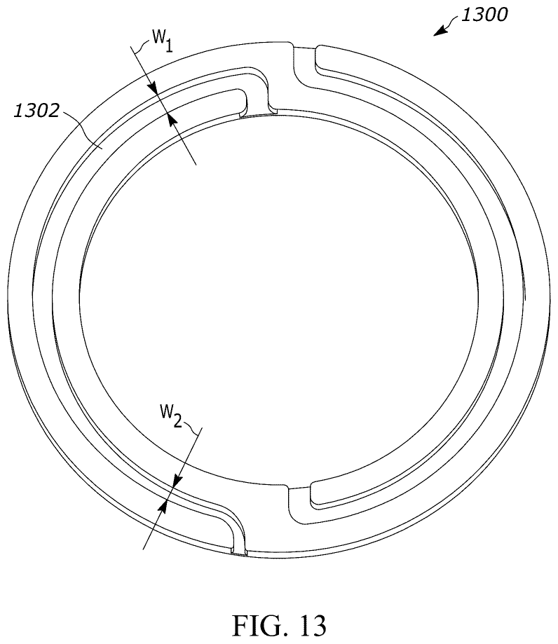

FIG. 13 illustrates a perspective view of a low frequency resonator and pressure relief structure for headphones 1300 with two channels 1302, at least one of which may have a constant width and the other of which may have a width that tapers, continuously if desired, from a wider width W1 to a narrower width W2. If the channels have the same length, the channel with the tapered width has a smaller average cross-section and consequently is tailored for a lower resonant frequency than the channel with a constant width.

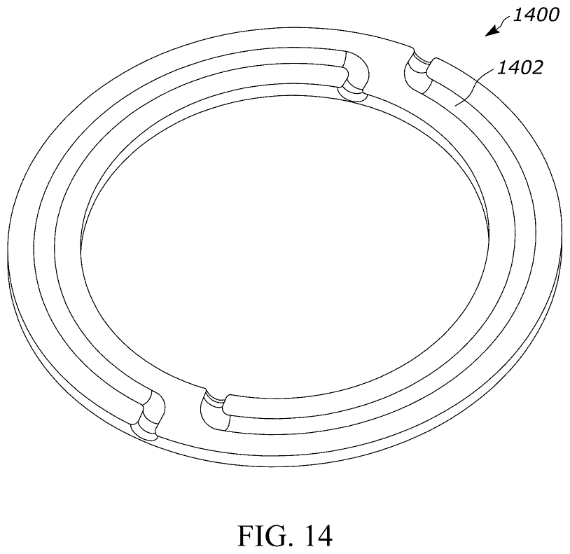

FIG. 14 illustrates a perspective view of a low frequency resonator and pressure relief structure for headphones 1400 with one or more channels 1402 having, as shown, a hemispherical transverse cross-section. The channels 1402 may be entirely closed in which case they have completely circular cross-sections, obviating the need for a cover.

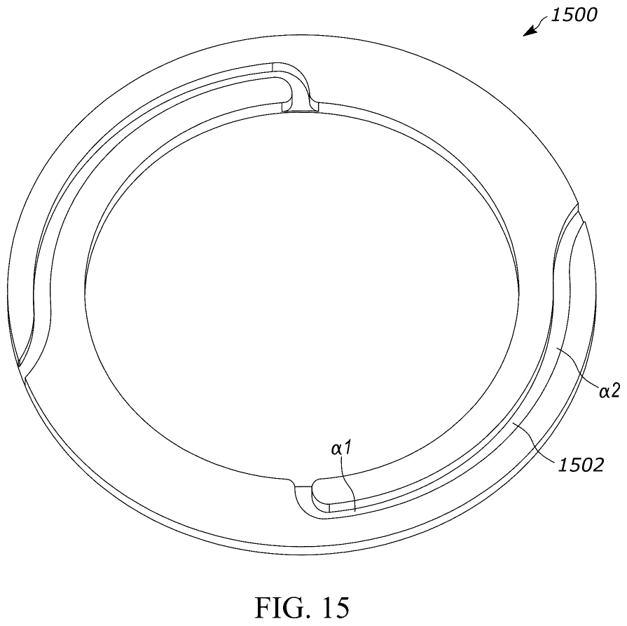

FIG. 15 illustrates a perspective view of a low frequency resonator and pressure relief structure for headphones 1500 with at least one channel 1502 having different inlet and outlet angles α1 and α2. In the example shown, the angle α2 is more obtuse than the angle α1.

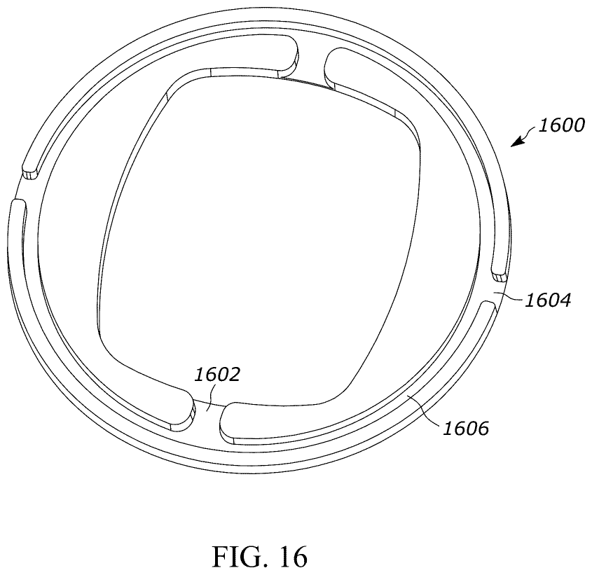

FIG. 16 illustrates a perspective view of a low frequency resonator and pressure relief structure 1600 for headphones consistent with present principles with two inlets 1602 and two outlets 1604 with a common channel 1606 connecting them. In the example shown, the inlets are diametrically opposed to each other and the outlets are diametrically opposed to each other, and the common channel 1606 is a continuous circular channel.

Resonance of the channel structure can be adjusted by changing channel length, changing the channels' total cross section, establishing an optimum number of channels, width of the channel, and/or depth of the channel. If there is a need for multiple resonant peaks, the channels can be designed to target specific resonant frequencies. For example, if two resonant peaks are required, two different channels are provided to resonate at the respective desired peaks.

Note that the outer peripheral shape of the resonator structure can have any desired shape, such as round, elliptical, oval, square, to follow the overall shape of the headphone housing. The resonator channels don't need to be parallel with the outer or inner edge of the structure or have parallel walls although in certain examples herein they do. The resonator covers don't need to be parallel to each other although in certain examples herein they are. The outer surfaces of resonator structure don't need to be flat although in certain examples herein they are. Channels can be formed with internal voids within the structure such as tubes overmolded into a final structure. The number of channels is not limiting unless so claimed. Multiple channels can run parallel with a single inlet or outlet. Channels can overlap in the azimuthal dimension if longer lengths are required. Left and right headphone ear cups may have different configurations to compensate for their differences (if left and right driver measurements are not a perfect match)

Although not intended to be limiting, present principles may operate as a Helmholtz resonator that is associated with the following equation:

$$f = ( kc / 2 π ) * {( A / VL )}^{1 / 2}$$

where:
f—resonant frequency of the structure (Hz)
c—speed of sound, 343 m/s at sea level and room temperature
A—total cross section of channels (m²)—If there are channels, A is a sum of all individual channel cross sections
V—volume of air trapped between earpad and head (m³)—V may be calculated from a 3D model in working position on a head—an accurate head 3D model is used for measurements and headphone shape development
L—Length of a single channel (center line of the channel) (m)
k—shaping coefficient experimentally determined for the specific headphone for which the device is to be used.

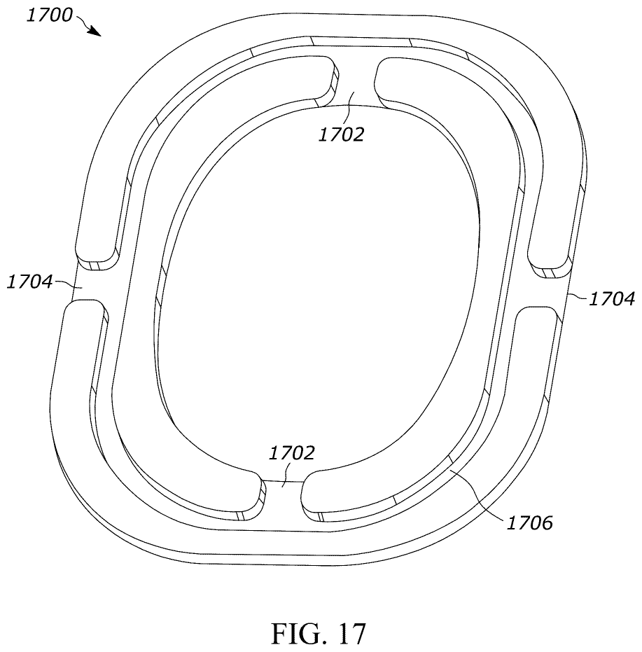

FIG. 17 illustrates a perspective view of a low frequency resonator and pressure relief structure 1700 for headphones consistent with present principles. The structure 1700 has two inlets 1702 and two outlets 1704 with a common channel 1706 connecting them. In the example shown, the inlets 1702 are diametrically opposed to each other and the outlets 1704 are diametrically opposed to each other, and the common channel 1706 is a continuous oblong channel.

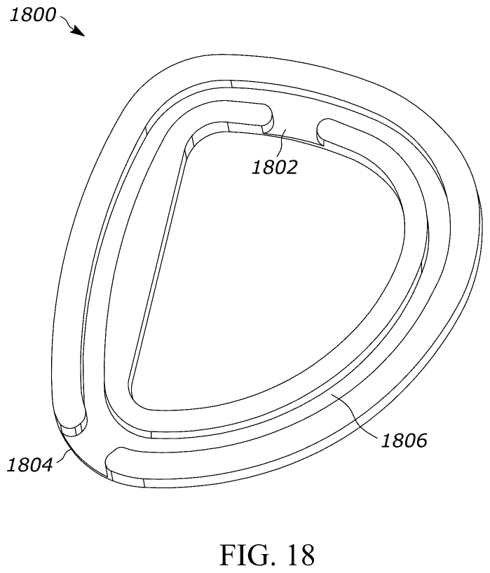

FIG. 18 illustrates a perspective view of a low frequency resonator and pressure relief structure 1800 for headphones consistent with present principles. Here, the structure 1800 has a single inlet 1802 and single outlet 1804 with a common channel 1806 connecting them. In the example shown, the inlet 1802 and the outlet 1804 are on opposite sides of the structure 1800, and the common channel 1806 is in a “D” shape (as is the structure 1800 itself).

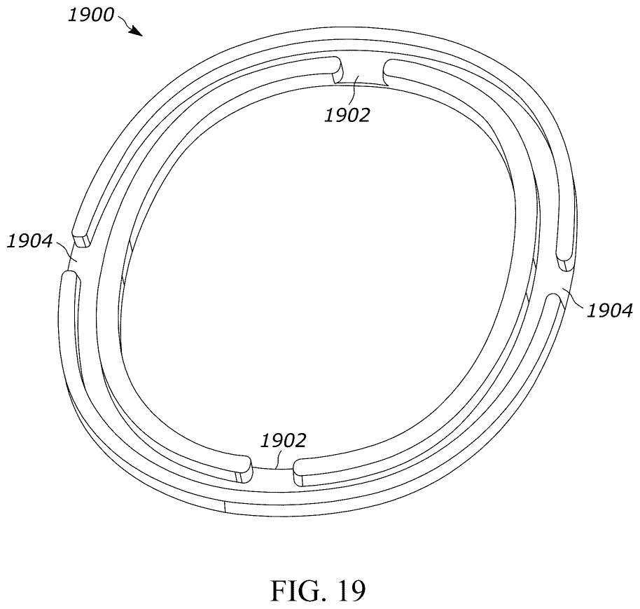

FIG. 19 illustrates a perspective view of another example low frequency resonator and pressure relief structure 1900 for headphones consistent with present principles. The structure 1900 has two inlets 1902 and two outlets 1904 with a common channel 1906 connecting them. In the example shown, the inlets 1902 are diametrically opposed to each other and the outlets 1904 are diametrically opposed to each other, and the common channel 1906 is a continuous circular channel. Distinguishing FIG. 19 from FIG. 16, note that the inner open area established by the structure 1900 is more rounded and oblong than the inner open area of the structure 1600 (which is more rectangular).

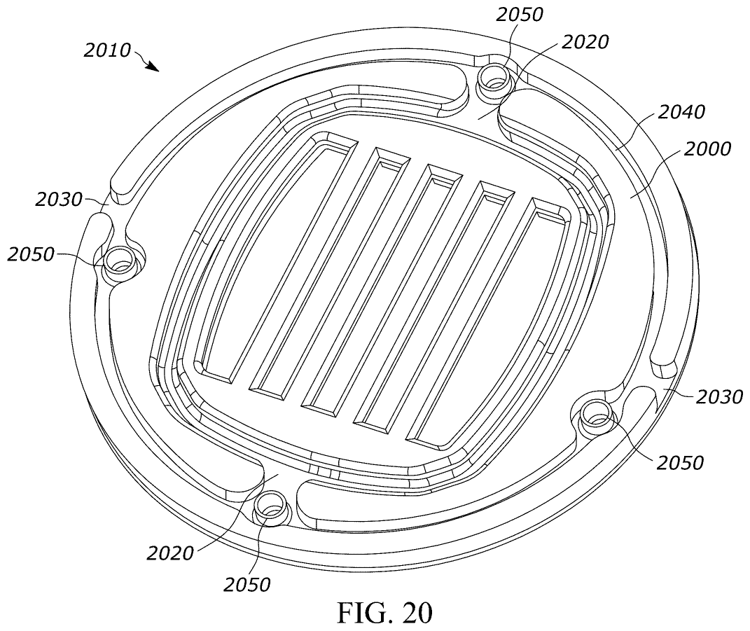

FIG. 20 illustrates a perspective view of a low frequency resonator and pressure relief structure 2000 for headphones consistent with present principles, as integrated into a transducer front plate 2010. As shown in this figure, the structure 2000 includes two inlets 2020 and two outlets 2030 with a common channel 2040 connecting them. In the example shown, the inlets 2020 are diametrically opposed to each other and the outlets 2030 are diametrically opposed to each other, and the common channel 2040 is a continuous circular channel. As also shown, the channel 2040 can split around mounting features 2050 (e.g., fastener holes).

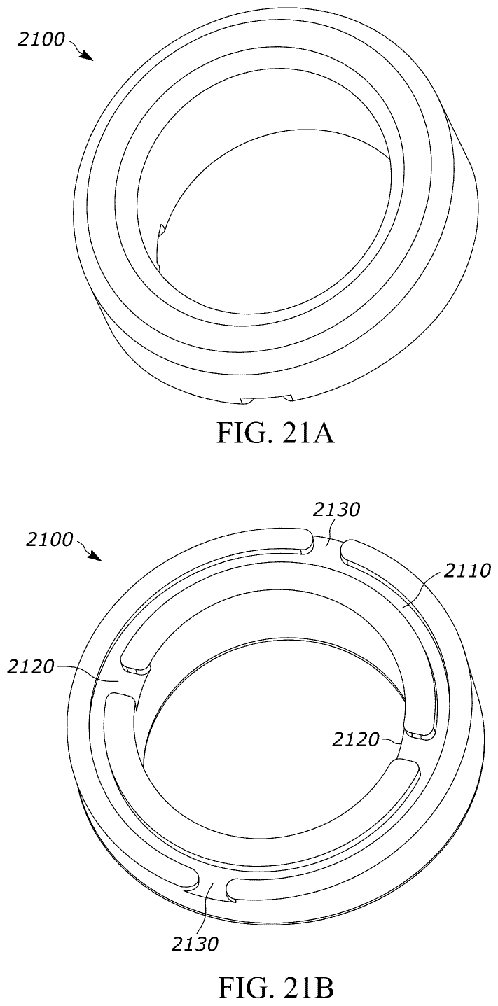

Now in reference to FIGS. 21A and 21B, these figures also show perspective views consistent with present principles. FIG. 21A shows a front perspective view of an earpad 2100 with integrated common resonator channel(s) 2110. FIG. 21B shows a rear perspective view of the earpad 2100 with integrated resonator channel(s) 2110. FIG. 21B further demonstrates two inlets 2120 and two outlets 2130 being included in the structure, with the common channel 2110 connecting them. The inlets 2120 are diametrically opposed to each other and the outlets 2130 are also diametrically opposed to each other. The common channel 2110 is again a continuous circular channel. Thus, it may be appreciated consistent with present principles that resonator channels can be integrated into earpads, with channels being closed when the earpad 2100 is mounted to the headphone front plate.

While the particular embodiments are herein shown and described in detail, it is to be understood that the subject matter which is encompassed by the present invention is limited only by the claims.

What is claimed is:

1. An apparatus comprising:
headphones with left and right ear cup assemblies to emit sound, at least a first one of the ear cup assemblies comprising:
a low frequency resonator and pressure relief structure for headphones shaped as a hollow disc with an endless outer periphery, an endless inner periphery, a first surface between the peripheries, and second surface opposed to the first flat surface, at least the first surface being formed with at least a first arcuate channel extending below the first surface toward the second surface, the first arcuate channel being between the peripheries and distanced therefrom, the first arcuate channel comprising a first end segment extending into the inner periphery and a second end segment extending into the outer periphery.

2. The apparatus of claim 1, wherein the peripheries of the hollow disc are round.

3. The apparatus of claim 1, wherein the first arcuate channel comprises a rectilinear transverse cross-section.

4. The apparatus of claim 1, wherein the first arcuate channel comprises a hemispherical transverse cross-section.

5. The apparatus of claim 1, comprising at least a second arcuate channel formed in the first surface.

6. The apparatus of claim 5, wherein the first arcuate channel has a first length and a first cross-sectional size and the second arcuate channel has a second length equal to the first length and a second cross-sectional size equal to the first cross-sectional size.

7. The apparatus of claim 5, wherein the first arcuate channel has a first length and a first cross-sectional size and the second arcuate channel has a second length not equal to the first length and a second cross-sectional size equal to the first cross-sectional size.

8. The apparatus of claim 5, wherein the first arcuate channel has a first length and a first cross-sectional size and the second arcuate channel has a second length equal to the first length and a second cross-sectional size not equal to the first cross-sectional size.

9. The apparatus of claim 5, wherein the first arcuate channel has a first length and a first cross-sectional size and the second arcuate channel has a second length not equal to the first length and a second cross-sectional size not equal to the first cross-sectional size.

10. The apparatus of claim 1, comprising a rounded edge between the first arcuate channel and the first end segment.

11. The apparatus of claim 5, comprising at least a third arcuate channel formed in the first surface.

12. The apparatus of claim 11, comprising at least a fourth arcuate channel formed in the first surface.

13. The apparatus of claim 5, wherein the first arcuate channel has a first longitudinal shape and the second arcuate channel has a second longitudinal shape different from the first longitudinal shape.

14. The apparatus of claim 1, wherein the first arcuate channel has a width that is continuously tapered along at least a portion of a length of the first arcuate channel.

15. The apparatus of claim 1, wherein the first end segment extends into the inner periphery at a first angle relative to the first arcuate channel and the second end segment extends into the outer periphery at a second angle relative to the first arcuate channel, the first angle being different than the second angle.

16. The apparatus of claim 1, wherein the headphones comprise planar magnetic headphones.

17. The apparatus of claim 1, comprising a cover completely covering the first surface.

18. The apparatus of claim 1, wherein the low frequency resonator and pressure relief structure for headphones is not part of an inner ear pad or outer plastic shell assembly of the first one of the ear cup assemblies.

19. The apparatus of claim 1, wherein the low frequency resonator and pressure relief structure for headphones is part of an inner ear pad of the first one of the ear cup assemblies.

20. The apparatus of claim 1, wherein the low frequency resonator and pressure relief structure for headphones is part of an outer plastic shell assembly of the first one of the ear cup assemblies.

21. Headphones, comprising:
at least a first ear cup assembly configured to produce sound;
at least a first disc in the first ear cup assembly, the first disc being round and hollow and defining an endless outer periphery, an endless inner periphery, a first flat surface between the peripheries, and second flat surface opposed to the first flat surface, at least the first flat surface being formed with at least a first arcuate channel extending below the first flat surface toward the second flat surface and configured to vent to both peripheries.

22. A method, comprising:
providing headphones with left and right ear cups;
providing, in each ear cup, a low frequency resonator and pressure relief structure for headphones configured with at least one channel configured to resonate sound at a first frequency “f”.

23. The method of claim 22, wherein the at least one channel is configured to resonate sound at the first frequency “f” according to:
$$f = ( kc / 2 π ) * {( A / VL )}^{1 / 2}$$
where:
c—speed of sound, 343 m/s at sea level and room temperature
A—total cross section are of the at least one channel (m2)
V—volume of air trapped between earpad of ear cup and head of wearer of the headphones (m3)
L—Length of the at least one channel (m)
k—shaping coefficient experimentally determined for the specific headphone for which the device is to be used
